(19) United States
(12) Patent Application Publication
(10) Pub. No.: US 2024/0287348 A1
(43) Pub. Date: Aug. 29, 2024

(54) HALOGENATED POLYURETHANE COATING COMPOSITIONS

(71) Applicant: Hewlett-Packard Development Company, L.P., Spring, TX (US)

(72) Inventors: Xiaoqi Zhou, San Diego, CA (US); Xulong Fu, San Diego, CA (US); Zhang-Lin Zhou, San Diego, CA (US)

(21) Appl. No.: 18/569,595

(22) PCT Filed: Jun. 25, 2021
(86) PCT No.: PCT/US2021/039044

§ 371 Date: Dec. 12, 2023

(51) Int. Cl. C09D 175/04; C09D 5/02; D06P 1/52; D06P 1/54; D06P 5/00

(52) U.S. Cl. CPC C09D 175/04; C09D 5/024; D06P 1/5285; D06P 1/54; D06P 5/002

(57) ABSTRACT

The present disclosure describes coating compositions containing halogenated polyurethanes, coated fabric media, and methods of making coated fabric media. In one example, a coating composition incudes an aqueous liquid vehicle, a cross-linkable polymeric binder, and a halogenated polyurethane dispersion. The halogenated polyurethane dispersion includes a polyurethane polymer strand having a halogen atom covalently bonded to the polyurethane polymer strand.

### BACKGROUND

Inkjet printing has become a popular way of recording images on various media. Some of the reasons include low printer noise, variable content recording, capability of high-speed recording, and multi-color recording. These features can be obtained at a relatively low price to consumers. As the popularity of inkjet printing increases, the types of use also increase providing demand for new print media, for example.

### BRIEF DESCRIPTION OF DRAWINGS

FIG. 1 schematically illustrates an example coating composition in accordance with the present disclosure;

FIG. 2 schematically illustrates another example coating composition in accordance with the present disclosure;

FIG. 3 schematically illustrates an example coated fabric medium in accordance with the present disclosure;

FIG. 4 schematically illustrates another example coated fabric medium in accordance with the present disclosure;

FIG. 5 shows a schematic portion of an example halogenated polyurethane polymer in accordance with the present disclosure;

FIG. 6 shows a schematic portion of another example halogenated polyurethane polymer in accordance with the present disclosure;

FIG. 7 shows a schematic portion of another example halogenated polyurethane polymer in accordance with the present disclosure;

FIG. 8 shows a schematic portion of yet another example halogenated polyurethane polymer in accordance with the present disclosure; and

FIG. 9 is a flowchart illustrating an example method of making a coated fabric medium in accordance with the present disclosure.

### DETAILED DESCRIPTION

The present disclosure describes coating compositions for fabric print media that can provide good printing image quality and durability while also having flame-retardant properties. In one example, a coating composition includes an aqueous liquid vehicle, a cross-linkable polymeric binder, and a halogenated polyurethane dispersion. The halogenated polyurethane dispersion includes a polyurethane polymer strand having a halogen atom covalently bonded to the polyurethane polymer strand. In some examples, the aqueous liquid vehicle can make up from 90 wt % to 99 wt % of the coating composition. In certain examples, the cross-linkable polymeric binder can include polyacrylate, polyurethane, vinyl-urethane, acrylic urethane, polyurethane-acrylic, polyether polyurethane, polyester polyurethane, polycaprolactam polyurethane, polyether polyurethane, alkyl epoxy resin, epoxy novolac resin, polyglycidyl resin, polyoxirane resin, polyamine, styrene maleic anhydride, or a combination thereof. In further examples, the cross-linkable polymeric binder can include an epoxy resin dispersion. The coating composition can also include a curing agent such as an amine, a polyamide, an anhydride, an imidazole, or a combination thereof. In certain examples, the halogen atom can include chlorine, bromine, or a combination thereof. In some examples, the halogenated polyurethane polymer strand can include polymerized monomers including a polyisocyanate, a polyol, and a monoalcohol end cap monomer, and the halogen atom can be included in the polyol, the monoalcohol end cap monomer, or both. In certain examples, the polyol, the monoalcohol end cap monomer, or both can include a polyalkylene oxide group. In still further examples, the halogen atom can be included in the monoalcohol end cap monomer and the polyalkylene oxide group can be a polypropylene oxide group or polyethylene oxide group included as a side chain of the polyol. In other examples, the halogen atom can be included in a side chain of the polyol and the polyalkylene oxide group can be a polypropylene oxide group or polyethylene oxide group included in the monoalcohol end cap monomer. In certain examples, the coating composition can also include particulates of calcium carbonate, silica, clay, metal oxide, or a combination thereof.

The present disclosure also describes coated fabric media. In one example, a coated fabric medium includes a fabric substrate and a coating on the fabric substrate. The coating includes a cross-linked polymeric network and a halogenated polyurethane polymer strand having a halogen atom covalently bonded to the polyurethane polymer strand. In some examples, the fabric substrate can include individual strands and void spaces between the individual strands, and the coating can be on surfaces of the individual strands such that the void spaces remain between the individual strands. In other examples, the coating can have a dry coat weight from 0.2 grams per square meter to 8 grams per square meter.

The present disclosure also describes methods of making coated fabric media. In one example, a method of making a coated fabric medium includes applying a coating composition to a fabric substrate and drying the coating composition to form a dry coating on the fabric substrate. The coating composition includes an aqueous liquid vehicle, a cross-linkable polymeric binder, and a polyurethane dispersion. The polyurethane dispersion includes a polyurethane polymer strand having a halogen atom covalently bonded to the polyurethane polymer strand. In some examples, the coating composition can also include a curing agent to cross-link the cross-linkable polymeric binder, and the method can also include mixing the curing agent in the coating composition before applying the coating composition to the fabric substrate. The method can also include curing the coating composition after applying the coating composition to the fabric substrate. In other examples, the method can also include calendar pressing the coated fabric substrate after drying.

It is noted that when discussing the coating compositions, coated fabric media, and methods of making coated fabric media, these discussions can be considered applicable to one another whether or not they are explicitly discussed in the context of that example. Thus, for example, when discussing polyurethanes used in coating compositions, such disclosure is also relevant to and directly supported in the context of the coated fabric media and methods, and vice versa. It is also understood that terms used herein will take on their ordinary meaning in the relevant technical field unless specified otherwise. In some instances, there are terms defined more specifically throughout the specification or included at the end of the present specification, and thus, these terms have a meaning as described herein.

Inkjet printing has become popular with wide width media, sometimes referred to as large format printing. Some large format printing applications include wall paper, signs, banners, and the like. These types of large media can be printed with images, designs, symbols, photographs, text, and so on. These media can be made of substrates such as paper, polymeric sheets, plastic film, textiles, and others. Printing on textile media is becoming increasingly popular because the textile media can be more environmentally friendly compared to some plastic films such as PVC film. Textiles can also have a low basis weight for shipping and handling, and low cost. Textile substrates can be coated with an ink-receiving coating to increase printability. However, it can be difficult to make coated fabric media with good durability.

In some cases, a fabric substrate can be coated with a relatively thick coating layer that can form a continuous film. This can provide good image quality for images printed on the fabric. However, this type of coating layer can often form a bending line or wrapping line when the printed fabric is subjected to folding or wrapping during installation, packaging, or shipping. Printed fabric is also often used in back-lit applications, and the bending line can appear as a dark line when the printed fabric is back-lit.

The use of printed fabric with back-lighting is also common in indoor locations. Fabrics used indoors in this way can be subject to industry standards for flame retardant properties. Polymeric coatings can often increase the flammability of fabric media.

In some examples, the coating compositions described herein can be used to coat fabric substrates without forming a continuous film. In particular, the coating compositions can be applied to fabric that is made up of yarn strands. The fabric can have void spaces between individual yarn strands. When the coating composition is applied to the fabric and dried, a coating can form on the individual yarn strands. The coating can have void spaces that correspond to the original void spaces between the yarn strands. Thus, the coating may not be a continuous film that is formed across the surface of the fabric. Instead, the coating can coat the individual yarn strands and void spaces can remain between the yarn strands. In some examples, this can increase the flexibility of the coated fabric compared to fabric with a continuous film coated on a surface of the fabric. This can also reduce or eliminate the bending line and dark line described above. The coating can also have good printability with inkjet inks, providing good printed image quality. The coated fabric can also have good flame retardant properties. The flame retardant properties can be increased by a polyurethane polymer having a halogen element covalently bonded to the polymer. Because the halogen is bonded to the polymer in the coating, migration of harmful halogen compounds from the coating into the environment can be reduced or eliminated.

In more detail, the coated fabric media described herein can provide good scratch resistance and rub resistance. As used herein, the terms “scratch resistance” and “rub resistance,” mean that the image printed on the medium is resistant to degradation as a result of scuffing or abrasion. The term “scuffing” refers to a blunt object being dragged across the printed image (like brushing fingertips along a printed image). The fabric medium may also fold over on itself and rub against its own surface, exposing the image to repeated surface interactions. Such scuffing can result in damage to the printed image. Scuffing may not remove colorant but may change the gloss of the area that was scuffed. The term “abrasion” means that force is applied to the printed image generating friction, usually from another object (such as a coin, fingernail, etc.), which can result in wearing, grinding or rubbing away of the printed image. Abrasion can result in removal of colorant (i.e., with a loss in optical density (OD)).

The coated fabric media can also provide good folding resistance. The term “folding resistance” means that the image printed on the medium is resistant to degradation as a result of being folded and being exposed to weight pressing on the fold while in the folded state. The fabric medium may be folded when stored and/or shipped. During storage and/or shipping, the folded medium may also be exposed to the weight of another object that is placed on top of the folded medium. The combination of the fold and the weight can cause the printed image to crack or experience colorant removal at or near the fold. However, as mentioned above, the fabric media described herein can be resistant to this type of damage.

The coated fabric media can also have flame retardant properties. The term “flame retardant” or “FR” means that the medium is resistant to catching on fire. The flame retardant coating reduces the flammability of the medium. In some examples, the coated fabric media can meet industrial FR standards such as NFPA 701. Additionally, in some examples the media can meet these standards while being devoid of free halogen compounds that might migrate into the environment.

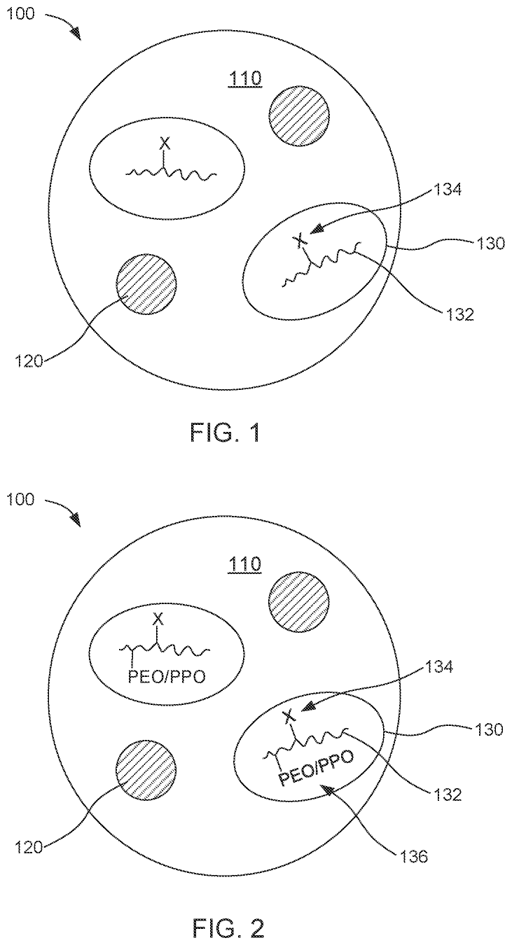

Turning now to examples of the coating compositions, FIG. 1 shows a schematic view of one example coating composition 100. The coating composition includes an aqueous liquid vehicle 110, a cross-linkable polymeric binder 120, and a halogenated polyurethane 130 dispersed in the aqueous liquid vehicle. The aqueous liquid vehicle can include water and may include additional ingredients such as a surfactant, an organic co-solvent, and others. The halogenated polyurethane includes polyurethane polymer strands 132 having a halogen atom 134 covalently bonded to the polyurethane polymer strand. The halogen can be on a side chain of the polymer strand, or on an end-cap of the polymer strand, or both. More specifically, in some examples, the halogen can be included in a polyol monomer or a monoalcohol end cap monomer that is polymerized to form the polyurethane polymer strand. Halogen atoms that can be used include fluorine, chlorine, bromine, and iodine. In certain examples, the halogen atom that is covalently bonded to the polymer strand can include chlorine, bromine, or a combination thereof. In further examples, the halogen atom can be bromine.

FIG. 2 shows another example coating composition 100. This example also includes a liquid vehicle 110, a cross-linkable polymeric binder 120, and a halogenated polyurethane 130. The halogenated polyurethane in this example includes a polymer strand 132 with a halogen atom 134 covalently bonded to the polyurethane polymer strand. This example also includes a polyalkylene oxide group 136 covalently bonded to the polyurethane polymer strand. In this particular example, the polyalkylene oxide is polyethylene oxide or polypropylene oxide, and therefore is abbreviated as “PEO/PPO.” In some examples, the polyurethane polymer strand can be polymerized from monomers including a polyol or multiple polyols and a monoalcohol end cap monomer or multiple manoalcohol end cap monomers. The halogen atom and the polyalkylene oxide group can both independently be included in either the polyols, or the monoalcohol end cap monomers, or both. For example, the polyurethane can be formed by polymerizing a mixture of monomers that includes two different polyols, where one polyol includes a covalently bonded halogen atom and where another polyol includes a polyalkylene oxide group. This can result in a polyurethane polymer strand that includes both halogen atoms and polyalkylene oxide groups along the backbone of the polymer strand. In another example, the polyurethane can be formed by polymerizing a mixture of monomers that includes multiple different monoalcohol end cap monomers, where one monoalcohol includes a halogen atom and where another monoalcohol includes a polyalkylene oxide group. This can result in a mixture of polyurethane polymer strands having halogen atoms and polyalkylene oxide groups at the terminal ends of the strands. Thus, various polyol monomers and monoalcohol end cap monomers can be used to make polyurethane polymer strands that have various combinations of halogen atoms and polyalkylene oxide groups along the backbone and/or at the terminal ends of the strands.

Regarding the proportions of the ingredients in the coating composition, in some examples, the cross-linkable polymeric binder and the halogenated polyurethane polymer can collectively make up from 80 wt % to 100 wt % of the solid components of the coating composition. In other examples, these can collectively make up from 80 wt % to 99 wt %, or from 85 wt % to 95 wt % of the solid components of the coating composition. The relative amounts of the cross-linkable polymeric binder and the halogenated polyurethane polymer can vary. In some examples, the cross-linkable polymeric binder can make up from 10 wt % to 80 wt % of the solid ingredients of the coating composition, or from 20 wt % to 70 wt %, or from 30 wt % to 60 wt % of the solid ingredients of the coating composition. In further examples, the halogenated polyurethane polymer can make up from 30 wt % to 80 wt %, or from 40 wt % to 70%, or from 40 wt % to 60 wt %, of the solid ingredients of the coating composition. In still further examples, a weight ratio of the cross-linkable polymeric binder to the halogenated polyurethane polymer can be from 5:1 to 1:5, or from 4:1 to 1:4, or from 2:1 to 1:2.

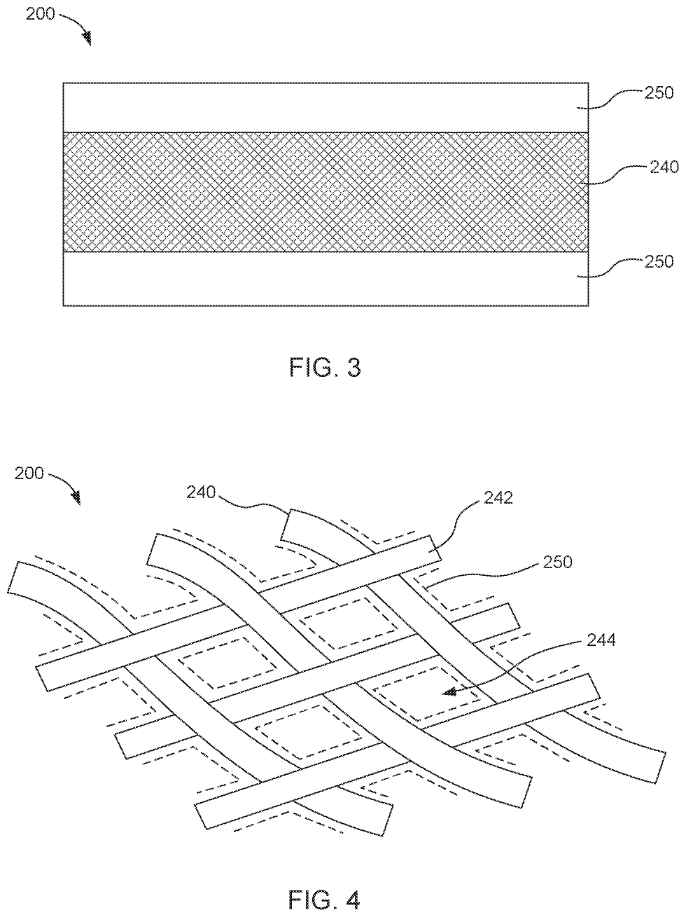

The coating compositions can also be coated on fabric print media. FIG. 3 shows a schematic cross-sectional view of one example coated fabric medium 200. The coated fabric medium includes a fabric substrate 240 and a coating 250 on the surface of the fabric substrate. In this particular example, a coating is present on both sides of the fabric substrate. The coating can be formed on both sides by applying a coating composition to both sides, such as by dipping the fabric in the coating composition or by other methods. The coating includes a cross-linked polymeric network and a halogenated polyurethane polymer strand having a halogen atom covalently bonded to the polyurethane polymer strand. The cross-linked polymeric network can be formed from the cross-linkable polymeric binder in the coating composition described above. In some examples, the cross-linkable polymeric binder can cross-link with itself and with the polyurethane polymer. In other examples, the polyurethane polymer can cross-link with itself or can remain uncross-linked. As mentioned above, coated fabric substrates that include the coatings described herein can have good image quality, durability, and flame retardant properties.

FIG. 3 above shows a schematic cross-sectional view of a coated fabric medium in which the coating is depicted as a simple layer deposited on a surface of the fabric. In practice, the coating composition can be applied to a fabric substrate including individual strands, such as yarn strands, and the coating composition can coat the individual strands instead of forming a continuous layer across the surface of the fabric. FIG. 4 shows a close-up view of such an example coated fabric medium 200. In this example, the fabric substrate 240 is made up of multiple individual yarn strands 242. Open void spaces 244 are present between the individual yarn strands. The coating composition is applied to this substrate to form a coating 250 that adheres to the individual yarn strands. The coating is not a continuous film, such that the void spaces remain open. In practice, some void spaces may be filled in by the coating composition, however, some void spaces can remain open. In certain examples, a majority of the void spaces can remain open after applying the coating.

In some examples, the void spaces can remain open because the coating composition can be applied at a relatively low coat weight. For example, the coat weight can be from 0.2 gsm to 8 gsm in some examples. In other examples, the coat weight can be less than 4.5 gsm or less than 2.5 gsm, provided that the coat weight is greater than zero. One way to produce a low coat weight when applying the coating composition is to use a relatively dilute coating composition. As mentioned above, the coating composition can include an aqueous liquid vehicle. In some examples, the aqueous liquid vehicle can make up from 90 wt % to 99 wt % of the coating composition. Therefore, the solid ingredients of the coating composition can make up from 1 wt % to 10 wt % of the coating composition. In some examples, the solid ingredients can include the cross-linkable polymeric binder, the halogenated polyurethane polymer, and other solid ingredients.

### Halogenated Polyurethane Polymers

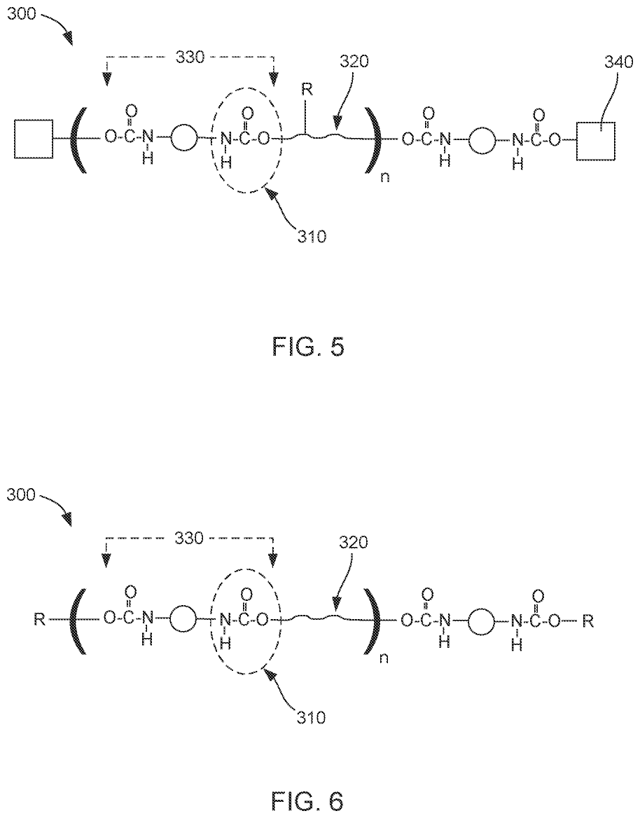

Turning to a more detailed description of the halogenated polyurethane polymer, FIG. 5 shows a chemical structure of an example halogenated polyurethane polymer strand 300 in accordance with the present disclosure. As mentioned above, this polymer can be present in the form of a polyurethane dispersion in the coating compositions described herein. As an initial matter in regard to the example schematic structure shown in FIG. 5, n can be from 1 to 18, from 1 to 14, from 1 to 10, from 2 to 18, from 2 to 10, from 1 to 5, or from 2 to 5, for example. R can be a halogenated alkyl or aromatic group. In other words, R can include an alkyl group or an aromatic group with a halogen atom covalently bonded thereto. The halogen atom can be chlorine or bromine in some examples. In certain examples, the halogen atom can be bromine.

With further reference to FIG. 5, several chemical moieties are schematically shown by way of example, including urethane linkage groups 310 (formed from isocyanate groups reacted with polyols). For example, the polyols 320 are shown schematically after polymerization. These polyols can be in the form of polymeric diols or short chained diols, and the polyols can include the R group, which is a halogenated alkyl or aromatic group. The polyols can react with isocyanates to form the urethane linkage groups. In more specific detail, the urethane linkage groups along a backbone of the polyurethane polymer can be formed by reacting these or other polyols with diisocyanates, which are shown at 330 as a backbone group after reaction with hydroxyl groups of the two adjacent compounds. The diisocyanates, shown as polymerized along the polyurethane backbone, are schematically represented by a circle with isocyanate groups on either side thereof. The polyurethane polymer strand can terminate with polymerized monoalcohol end cap monomers. These can be compounds having a single hydroxyl group that can react with an isocyanate group. Therefore, when a monoalcohol reacts with a reactive isocyanate group of a polymer strand, the polymerization can stop because the monoalcohol does not include a second hydroxyl group that would be available to react with an additional diisocyanate molecule. In FIG. 5, the monoalcohol end cap monomer has already polymerized and bonded to one of the polymerized diisocyanates. The remainder of the monoalcohol end cap monomer, other than the hydroxyl group, is represented as a square end cap group 340 in FIG. 5.

The polyurethane polymer strand shown in FIG. 5 can be made by polymerizing a polyol that includes the halogen-containing R group with a diisocyanate. A monoalcohol end cap monomer can then be added to polymerize with a reactive isocyanate group and terminate the polymerization reaction. In certain examples, the polymerization can be performed in a solvent such as acetone, and then the acetone can be replaced with water to form a dispersion of polyurethane particles.

In other examples, the halogen can be in the monoalcohol end cap monomer. FIG. 6 shows an example of this type of halogenated polyurethane polymer strand 300. In this example, a diisocyanate 330 is polymerized with any polyol 320, and then a monoalcohol having the chemical structure “R—OH” can be added to form end caps on the polymer strand. In this case, the end caps are the R group, which is an alkyl or aromatic group having a halogen atom covalently bonded thereto. Thus, the halogen atom can be present in the end cap groups. As in the previous example, the diisocyanates bond to the polyols through urethane linkages 310. Although not depicted in a figure, in other examples, halogen atoms can be present in end cap groups and as side chains in polymerized polyols along the backbone of the polyurethane polymer strand.

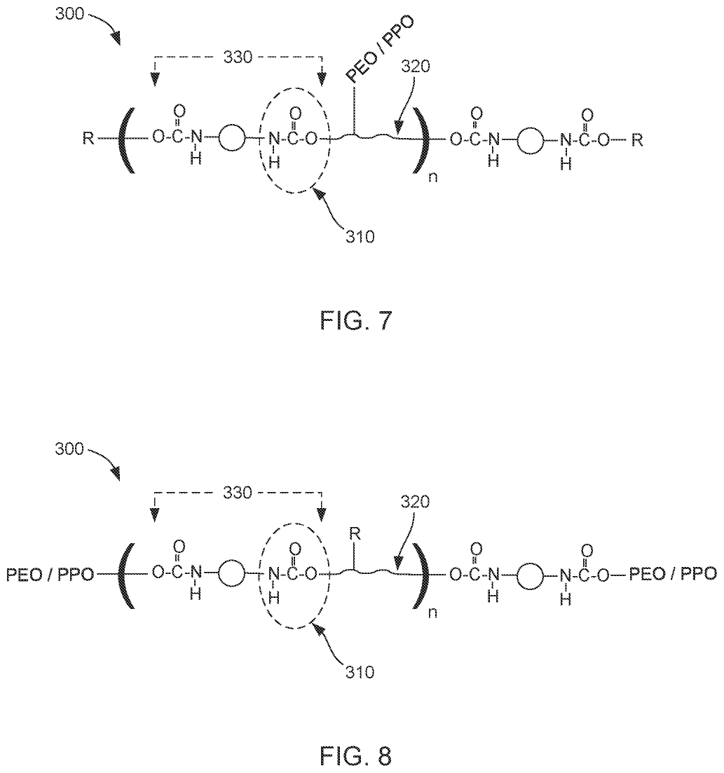

In some examples, the halogenated polyurethane polymer can also include polyalkylene oxide groups, such as polyethylene oxide or polypropylene oxide. In various examples, the polyalkylene oxide groups can be present as side chains along the backbone, or as end cap groups. FIG. 7 shows one example halogenated polyurethane polymer strand 300 that includes a polyethylene oxide or polypropylene oxide “PEO/PPO” group that is a part of a polyol 320 polymerized in the backbone of the polymer strand. As in the previous example, the diisocyanates 330 bond to the polyols through urethane linkages 310. This example also includes R groups as end cap groups, which contain the halogen atoms.

FIG. 8 shows a different example halogenated polyurethane polymer strand 300. This example includes PEO/PPO groups as the end cap groups. The R group, containing the covalently bonded halogen atom, is in a polyol 320 that polymerizes with the diisocyanate 330 in the backbone of the polymer strand. As in the previous examples, the diisocyanates bond to the polyols through urethane linkages 310. Although not depicted in the figures, other arrangements can also be made that can include polyalkylene oxide groups and/or halogenated groups in either the backbone, end cap groups, or a combination thereof. Therefore, in some examples, the halogenated polyurethane polymer can include polymer strands that include polyalkylene oxide groups in the backbone, end cap groups, or both, and halogenated groups in the backbone, end cap groups, or both.

The number average molecular weight of the halogenated polyurethane polymers can be from 3,000 Mn to 500,000 Mn, from 10,000 Mn to 400,000 Mn, from 20,000 Mn to 250,000 Mn, from 10,000 Mn to 200,000 Mn, or from 50,000 Mn to 500,000 Mn, as measured by gel permeation chromatography, for example.

The halogenated polyurethane polymer can be in the form of a particle dispersion, with particles having a D50 particle size from 25 nm to 3 μm, from 25 nm to 1 μm, from 40 nm to 500 nm, from 60 nm to 300 nm, or from 25 nm to 250 nm, for example. “D50” particle size is defined as the particle size at which about half of the particles are larger than the D50 particle size and about half of the other particles are smaller than the D50 particle size (by weight based on the particle content of the particles being sized). As used herein, particle size with respect to the polyurethane particles can be based on volume of the particle size normalized to a spherical shape for diameter measurement. Particle size information can also be determined and/or verified using a scanning electron microscope (SEM).

In accordance with examples of the present disclosure, these and other types of polyurethane particles prepared in accordance with the present disclosure can include polyurethane polymers with an acid number from 0 to 10 mg KOH/g, from 0 to 5 mg KOH/g, or 0 mg KOH/g. The term “acid value” or “acid number” refers to the mass of potassium hydroxide (KOH) in milligrams that can be used to neutralize one gram of substance (mg KOH/g), such as the various polymers disclosed herein. This value can be determined, in one example, by dissolving or dispersing a known quantity of a material in organic solvent and then titrating with a solution of potassium hydroxide (KOH) of known concentration for measurement.

It is noted that the structure shown in the figures above are not intended to depict a specific polymer, but rather to show examples of the types of groups that may be present along the polyurethane backbone of the halogenated polyurethane polymers. For example, there may be additional polymerized polymeric diols, polymerized isocyanates, urethane linkage groups, polyalkylene oxides, or even other moieties not shown in this example, such as epoxides, organic acids, etc. provided by other diols. Examples of other types of compounds that can be used include various organic acid diols. C2-C20 aliphatic diols, glycidyl-containing diols to generate epoxy functional groups, functional amine groups derived from isocyanate groups that do not form a urethane linkage group, acid groups introduced from sulfonic acid or carboxylic acid diamines, or the like. These and other types of moieties can be included.

Example diisocyanates that can be used to prepare the polyurethane polymer (used subsequently to form the polyurethane particles) include 2,2,4 (or 2, 4, 4)-trimethylhexane-1,6-diisocyanate (TMDI), hexamethylene diisocyanate (HDI), methylene diphenyl diisocyanate (MDI), isophorone diisocyanate (IPDI), and/or 1-Isocyanato-4-[(4-isocyanatocyclohexyl)methyl]cyclohexane (H12MDI), etc., or a combination thereof, as shown below. Others can likewise be used alone, or in combination with these diisocyanates, or in combination with other diisocyanates not shown.

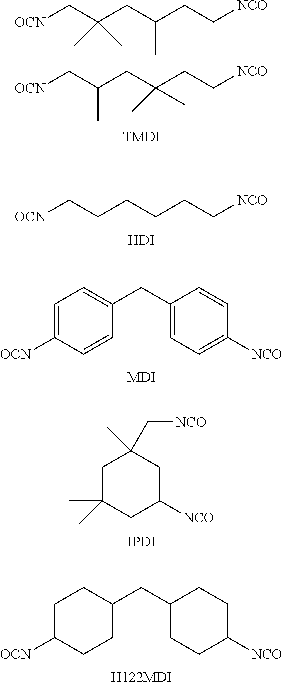

In further detail, diols and/or polyols can be included to react with the isocyanates to form the urethane linkage groups. In some examples, these can be chloro- or bromo-diols. Additionally, chloro- or bromo-monoalcohols can be used as end cap monomers. Several examples of halogenated alkyl alcohols are shown below.

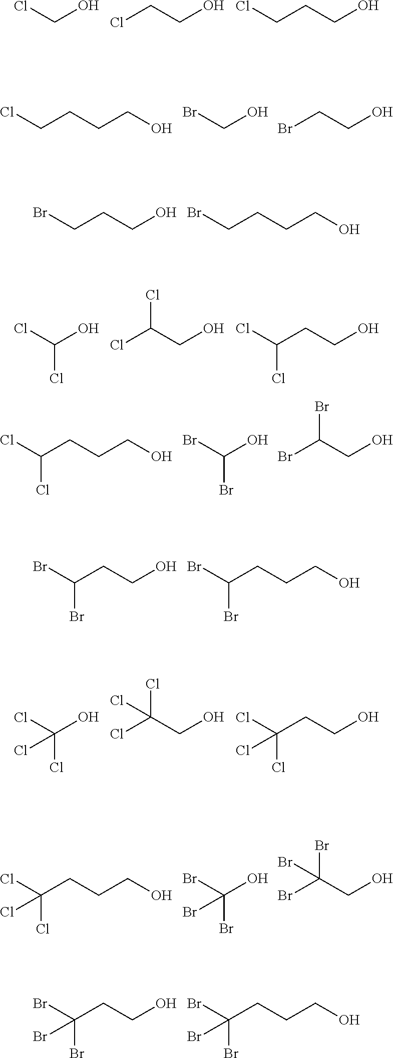

Several examples of halogenated aryl alcohols are shown below.

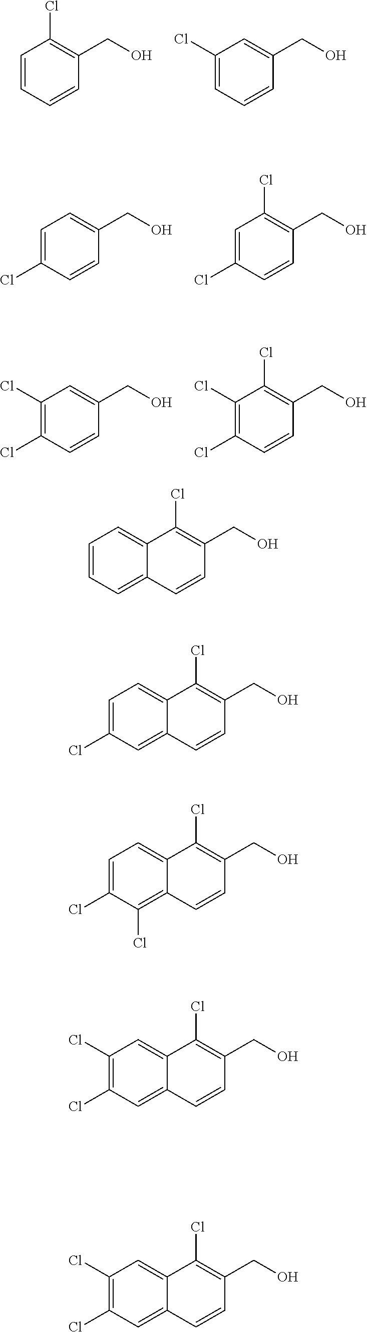

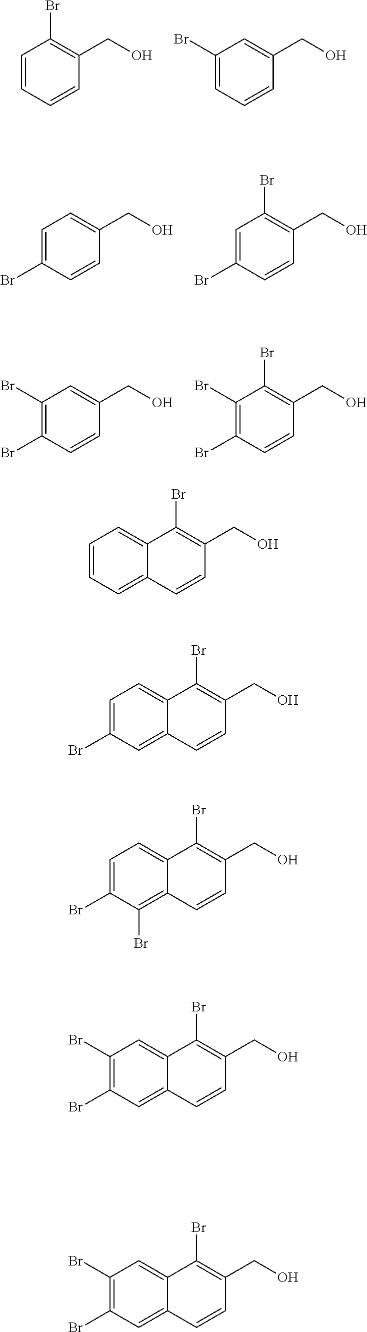

Several examples of halogenated alkyl diols are shown below.

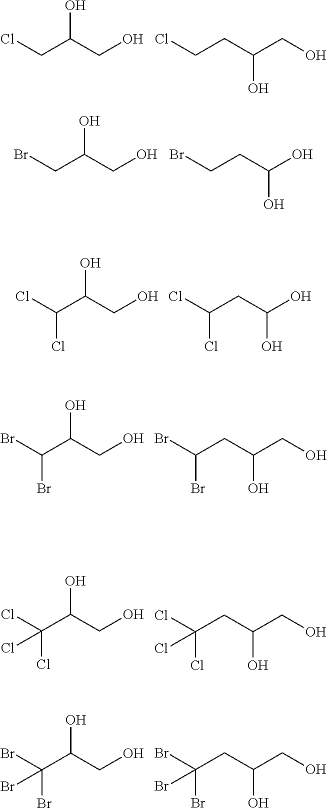

Several examples of halogenated aryl diols are shown below.

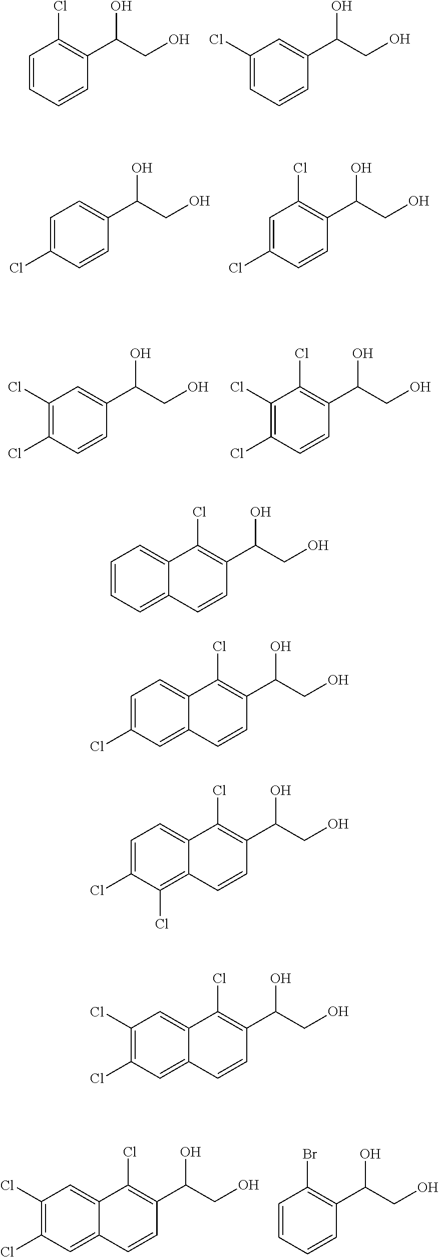

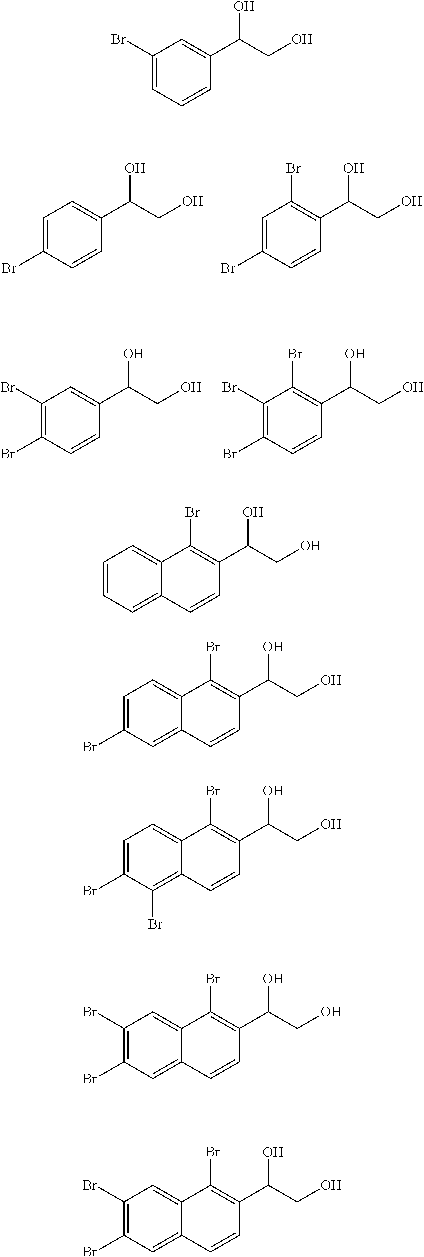

The halogenated alcohols described above can be used as end cap monomers when forming the halogenated polyurethane polymer. The halogenated diols can be polymerized with diisocyanates along the backbone of the halogenated polyurethane polymer strand.

As mentioned, polyalkylene oxides can be included, for example, as pendant groups in the form of side chain groups or end cap groups. The polyalkylene oxides can include polyethylene oxide (PEO), polypropylene oxide (PPO), or a hybrid of both PEO and PPO, which includes both types of monomeric units as a hybrid polyalkylene. These polyalkylene oxides can be grafted or copolymerized during formation of a polyurethane pre-polymer to provide polyalkylene oxide moieties along the backbone. The polyalkylene oxide moieties can have a number average molecular weight (Mn) from 200 Mn to 15,000 Mn, from 500 Mn to 15,000 Mn, from 1,000 Mn to 12,000 Mn, from 2,000 Mn to 10,000 Mn, or from 3,000 Mn to 8,000 Mn, which can be measured by gel permeation chromatography.

Some example polyalkylene oxide diols can include difunctional polyethylene glycol monomethyl ether, such as YMER™ N-120, YMER™ N-180, and YMER™ N-90, available from Perstorp Holding AB (Sweden). These can be polymerized in the backbone of the polyurethane polymer. Examples of polyalkylene oxide monoalcohols that can be used include polyethylene oxide-based monoalcohols and polypropylene oxide-based monoalcohols, such as poly(ethylene glycol) mono-methyl ether; poly(ethylene glycol) mono-ethyl ether; poly(ethylene glycol) mono-propyl ether; poly(ethylene glycol) mono-butyl ether; poly(ethylene glycol) mono-dodecyl ether; poly(ethylene glycol) mono-undecyl ether; poly(ethylene glycol) mono-phenyl ether; poly(propylene glycol) mono-methyl ether; poly(propylene glycol) mono-ethyl ether; poly(propylene glycol) mono-propyl ether; poly(propylene glycol) mono-butyl ether; poly(propylene glycol) mono-dodecyl ether; poly(propylene glycol) mono-undecyl ether; poly(propylene glycol) mono-phenyl ether, and combinations thereof.

In further detail, in some examples, the halogenated polyurethane polymers can be prepared with polymeric portions from any of a number of other types of polymeric diols. Example polymeric diols that can be used include polyether diols (or polyalkylene diols), such as polyethylene oxide diols, polypropylene oxide diols (or a hybrid diol of polyethylene oxide and polypropylene oxide), or polytetrahydrofuran. Other polymeric diols that can be used include polyester diols, such as polyadipic ester diol, polyisophthalic acid ester diol, polyphthalic acid ester diol; or polycarbonate diols, such as hexanediol based polycarbonate diol, pentanediol based polycarbonate diol, hybrid hexanediol and pentanediol based polycarbonate diol, etc. Combinations of polymeric diols can also be used to prepare polyurethanes such as polycarbonate ester polyether-type polyurethanes, or other hybrid-types of polyurethane particles. In forming the polymer, the reaction between the polymeric diols and the isocyanates can occur in the presence of a catalyst in acetone under reflux. The resultant polymer may include polymerized polymeric diols and polymerized isocyanates with urethane linkage groups along the polymer. In some specific examples, other reactants may also be used as mentioned (other types of diols, amines, etc.).

In some examples, the polyurethane polymer can be prepared with an NCO/OH ratio from 1.2 to 2.2. In another example, the polyurethane polymer can be prepared with an NCO/OH ratio from 1.4 to 2.0. In yet another example, the polyurethane polymer can be prepared using an NCO/OH ratio from 1.6 to 1.8.

The halogenated polyurethane can be made in the form of particles dispersed in a liquid vehicle. In some examples, the liquid vehicle can include water. The liquid vehicle can also include additional ingredients, such as surfactants and co-solvents.

Some example commercially available polyurethane dispersions that have a covalently bonded halogen atom as described above include SANCURE® 1004A, SANCURE® 1073C (available from Lubrizol Advanced Materials, Inc., USA), MACEKOTE® HFR 423-Z (available from Mace Polymers & Additives, USA), SOLUCOTE® Base FR 513-55K, and SOLUCOTE® Top FR 731-25K (available from DSM, Netherlands).

As explained above, the halogenated polyurethane dispersion can be combined with an addition cross-linkable polymeric binder and a liquid vehicle to form a coating composition. Additional ingredients that may be included in the coating composition can include additional polymers, cross-linking agents, curing agents, inorganic fillers, processing aids such as pH control agents, thickening agents, and others.

### Cross-Linkable Polymeric Binder

The additional cross-linkable polymeric binder that may be included in the coating composition can be selected from a variety of types of polymer. In some examples, the additional polymer can be devoid of halogen atoms. In certain examples, the cross-linkable polymeric binder can be an additional type of polyurethane polymer. In other examples, the cross-linkable polymeric binder can be another type of polymer, such as polyacrylate, vinyl-urethane, acrylic urethane, polyurethane-acrylic, polyether polyurethane, polyester polyurethane, polycaprolactam polyurethane, polyether polyurethane, epoxy resin, alkyl epoxy resin, epoxy novolac resin, polyglycidyl resin, polyoxirane resin, polyamine, styrene maleic anhydride, a copolymer thereof, or a mixture thereof.

In one example, the additional polymer included in the coating composition can be a polyacrylate. Example polyacrylate based polymers can include polymers made by hydrophobic addition monomers including, but not limited to, C1-C12 alkyl acrylate and methacrylate (e.g., methyl acrylate, ethyl acrylate, n-propyl acrylate, isopropyl acrylate, n-butyl acrylate, isobutyl acrylate, sec-butyl acrylate, tert-butyl acrylate, 2-ethylhexyl acrylate, octyl arylate, methyl methacrylate, ethyl methacrylate, n-propyl methacrylate, isopropyl methacrylate, n-butyl methacrylate, isobutyl methacrylate, sec-butyl methacrylate, tert-butyl methacrylate), and aromatic monomers (e.g., styrene, phenyl methacrylate, o-tolyl methacrylate, m-tolyl methacrylate, p-tolyl methacrylate, benzyl methacrylate), hydroxyl containing monomers (e.g., hydroxyethylacrylate, hydroxyethylmthacrylate), carboxylic containing monomers (e.g., acrylic acid, methacrylic acid), vinyl ester monomers (e.g., vinyl acetate, vinyl propionate, vinylbenzoate, vinylpivalate, vinyl-2-ethylhexanoate, vinylversatate), vinyl benzene monomer, C1-C12 alkyl acrylamide and methacrylamide (e.g., t-butyl acrylamide, sec-butyl acrylamide, N,N-dimethylacrylamide), crosslinking monomers (e.g., divinyl benzene, ethyleneglycoldimethacrylate, bis(acryloylamido)methylene), or combinations thereof. Polymers made from the polymerization and/or copolymerization of alkyl acrylate, alkyl methacrylate, vinyl esters, and styrene derivatives may also be useful.

In another example, the additional polymer in the coating composition can include a polyurethane polymer that is different from the halogenated polyurethane polymer. The additional polyurethane polymer can be hydrophilic. The polyurethane can be formed in one example by reacting an isocyanate with a polyol. Example isocyanates used to form the polyurethane polymer can include toluenediisocyanate, 1,6-hexamethylenediisocyanate, diphenylmethanediisocyanate, 1,3-bis(isocyanatemethyl)cyclohexane, 1,4-cyclohexyldiisocyanate, p-phenylenediisocyanate, 2,2,4(2,4,4)-trimethylhexamethylenediisocyanate, 4,4′-dicychlohexylmethanediisocyanate, 3,3′-dimethyldiphenyl, 4,4′-diisocyanate, m-xylenediisocyanate, tetramethylxylenediisocyanate, 1,5-naphthalenediisocyanate, dimethyltriphenylmethanetetraisocyanate, triphenylmethanetriisocyanate, tris(isocyanatephenyl)thiophosphate, or combinations thereof. Commerically available isocyanates can include RHODOCOAT™ WT 2102 (available from Rhodia AG, Germany), BASONAT® LR 8878 (available from BASF Corporation, N. America), DESMODUR® DA, and BAYHYDUR® 3100 (available from Bayer AG, Germany). In some examples, the isocyanate can be protected from water. Example polyols can include 1,4-butanediol; 1,3-propanediol; 1,2-ethanediol; 1,2-propanediol; 1,6-hexanediol; 2-methyl-1,3-propanediol; 2,2-dimethyl-1,3-propanediol; neopentyl glycol; cyclohexanedimethanol; 1,2,3-propanetriol; 2-ethyl-2-hydroxymethyl-1,3-propanediol; or combinations thereof. In some examples, the isocyanate and the polyol can have less than three functional end groups per molecule. In another example, the isocyanate and the polyol can have less than five functional end groups per molecule. In yet another example, the polyurethane can be formed from a polyisocyanate having two or more isocyanate functionalities and a polyol having two or more hydroxyl or amine groups. Example polyisocyanates can include diisocyanate monomers and oligomers.

Example secondary polyurethane polymers can include polyester based polyurethanes, U910, U938 U2101 and U420; polyether-based polyurethane, U205, U410, U500 and U400N; polycarbonate-based polyurethanes, U930, U933, U915 and U911; castor oil-based polyurethane, CUR21, CUR69, CUR99 and CUR991; or combinations thereof. (All of these polyurethanes are available from Alberdingk Boley Inc., North Carolina).

In some examples the additional polyurethane can be aliphatic or aromatic. In one example, the polyurethane can include an aromatic polyether polyurethane, an aliphatic polyether polyurethane, an aromatic polyester polyurethane, an aliphatic polyester polyurethane, an aromatic polycaprolactam polyurethane, an aliphatic polycaprolactam polyurethane, or a combination thereof. In another example, the additional polyurethane can include an aromatic polyether polyurethane, an aliphatic polyether polyurethane, an aromatic polyester polyurethane, an aliphatic polyester polyurethane, or a combination thereof. Example commercially-available polyurethanes can include; NEOPAC® R-9000, R-9699, and R-9030 (available from Zeneca Resins, USA), PRINTRITE™ DP376 and SANCURE® AU4010 (available from Lubrizol Advanced Materials, Inc., USA), and HYBRIDUR® 570 (available from Air Products and Chemicals Inc., USA), SANCURE® 2710, AVALURE® UR445 (which are equivalent copolymers of polypropylene glycol, isophorone diisocyanate, and 2,2-dimethylolpropionic acid, having the International Nomenclature Cosmetic Ingredient name “PPG-17/PPG-34/IPDI/DMPA Copolymer”), SANCURE® 878, SANCURE® 815, SANCURE® 1301, SANCURE® 2715, SANCURE® 2026, SANCURE® 1818, SANCURE® 853, SANCURE® 830, SANCURE® 825, SANCURE® 776, SANCURE® 850, SANCURE® 12140, SANCURE® 12619, SANCURE® 835, SANCURE® 843, SANCURE® 898, SANCURE® 899, SANCURE® 1511, SANCURE® 1514, SANCURE® 1517, SANCURE® 1591, SANCURE® 2255, SANCURE® 2260. SANCURE® 2310, SANCURE® 2725, SANCURE®12471, (all commercially available from Lubrizol Advanced Materials, Inc., USA), or combinations thereof.

In some examples, the polyurethane can be crosslinked using a crosslinking agent. In one example, the crosslinking agent can be a blocked polyisocyanate. In another example, the blocked polyisocyanate can be blocked using polyalkylene oxide units. In some examples, the blocking units on the blocked polyisocyanate can be removed by heating the blocked polyisocyanate to a temperature at or above the deblocking temperature of the blocked polyisocyanate in order to yield free isocyanate groups. An example blocked polyisocyanate can include BAYHYDUR® VP LS 2306 (available from Bayer AG, Germany). In another example, the crosslinking can occur at trimethyloxysilane groups along the polyurethane chain. Hydrolysis can cause the trimethyloxysilane groups to crosslink and form a silesquioxane structure. In another example, the crosslinking can occur at acrylic functional groups along the polyurethane chain. Nucleophilic additions to an acrylate group by an acetoacetoxy functional group can allow for crosslinking on polyurethanes including acrylic functional groups. In other examples the polyurethane polymer can be a self-crosslinked polyurethane. Self-crosslinked polyurethanes can be formed, in one example, by reacting an isocyanate with a polyol.

In another example, the additional polymer in the coating composition can include an epoxy. The epoxy can be an alkyl epoxy resin, an alkyl aromatic epoxy resin, an aromatic epoxy resin, epoxy novolac resins, epoxy resin derivatives, or combinations thereof. In some examples, the epoxy can include an epoxy functional resin having one, two, three, or more pendant epoxy moieties.

In one example, the epoxy resin can be self-crosslinked. Self-crosslinked epoxy resins can include polyglycidyl resins, polyoxirane resins, or combinations thereof. Polyglycidyl and polyoxirane resins can be self-crosslinked by a catalytic homopolymerization reaction of the oxirane functional group or by reacting with co-reactants such as polyfunctional amines, acids, acid anhydrides, phenols, alcohols, and/or thiols.

The coating composition can also include an epoxy resin hardener. Some examples of the epoxy resin may be crosslinked by the epoxy resin hardener. Epoxy resin hardeners can be included in solid form, in a water emulsion, and/or in a solvent emulsion. The epoxy resin hardener, in one example, can include liquid aliphatic amine hardeners, cycloaliphatic amine hardeners, amine adducts, amine adducts with alcohols, amine adducts with phenols, amine adducts with alcohols and phenols, amine adducts with emulsifiers, amine adducts with alcohols and emulsifiers, polyamines, polyfunctional polyamines, acids, acid anhydrides, phenols, alcohols, thiols, and combinations thereof. Examples of suitable commercially available epoxy resin hardeners can include ANQUAWHITE®100 (from Air Products and Chemicals Inc., USA), ARADUR® 3985 (from Huntsman International LLC, USA), EPIKURET 8290-Y-60 (from Hexion, USA), and combinations thereof.

Some examples of commercially available epoxy functional resins can include ANCAREZ® AR555 (from Air Products and Chemicals Inc., USA), EPI-REZ™ 3510W60, EPI-REZ™ 3515W6, and EPI-REZ™ 3522W60 (all available from Hexion Specialty Chemicals, USA), and combinations thereof.

In some examples, the epoxy functional resin can be an aqueous dispersion of an epoxy resin. Examples of commercially available aqueous dispersions of epoxy resins can include ARALDITE® PZ 3901, ARALDITE® PZ 3921, ARALDITE® PZ 3961-1, ARALDITE® PZ 323 (from Huntsman International LLC, USA), WATERPOXY® 1422 (from BASF, Germany), ANCAREZ® AR555 (Air Products and Chemicals, Inc., USA), and combinations thereof.

In still another example, the cross-linkable polymeric binder can include a styrene maleic anhydride (SMA). In one example, the SMA can include NOVACOTE® 2000 (Georgia-Pacific Chemicals LLC, USA). In another example, the styrene maleic anhydride can be combined with an amine terminated polyethylene oxide (PEO), an amine terminated polypropylene oxide (PPO), a copolymer thereof, or a combination thereof. The combination of a styrene maleic anhydride with an amine terminated PEO and/or PPO can strengthen the polymeric network by crosslinking the acid carboxylate functionalities of the SMA to the amine moieties on the amine terminated PEO and/or PPO. The amine terminated PEO and/or PPO, in one example, can include amine moieties at one or both ends of the PEO and/or PPO chain, and/or as branched side chains on the PEO and/or PPO. The combination of the styrene maleic anhydride with an amine terminated PEO and/or PPO can provide the finishing coating 22 with the glossy features of the SMA while reducing or eliminating the brittle nature of the SMA. Examples of commercially available amine terminated PEO and/or PPO compounds include JEFFAMINE® XTJ-500, JEFFAMINE® XTJ-502, and JEFFAMINE® XTJ D-2000 (all from Huntsman International LLC, USA). In some examples, a weight ratio of the SMA to the amine terminated PEO and/or PPO can range from 100:1 to 2.5:1. In other examples, a weight ratio of the SMA to the amine terminated PEO and/or PPO can range from 90:1 to 10:1. In yet other examples, a weight ratio of the SMA to the amine terminated PEO and/or PPO can range from 75:1 to 25:1.

In certain examples, the cross-linkable polymeric binder can cross-link to itself when the coating composition is applied and dried or cured. In some cases, the cross-linkable polymeric binder can cross-link to itself to form a crosslinked polymer network, without cross-linking to the halogenated polyurethane polymer. In other examples, the halogenated polyurethane polymer can cross-link together with the cross-linkable polymeric binder. In further examples, the halogenated polyurethane polymer can cross to itself but not to the cross-linkable polymeric binder. Thus, the halogenated polyurethane polymer and the cross-linkable polymeric binder can cross-link independently to form two discrete cross-linked networks. In certain examples, the two cross-linked networks can be entangled or can appear layered on one another.

### Additional Coating Ingredients

In addition to the liquid vehicle, halogenated polyurethane polymer, and cross-linkable polymeric binder, the coating composition can include other solids such as inorganic fillers. Examples can include inorganic pigment(s), such as white inorganic pigments if the media is intended to be white, for example. Examples of inorganic pigments that may be used include, but are not limited to, aluminum silicate, kaolin clay, a calcium carbonate, silica, alumina, boehmite, mica and talc, or combinations or mixtures thereof. In some examples, the inorganic pigment includes a clay or a clay mixture. In some examples, the inorganic pigment includes a calcium carbonate or a calcium carbonate mixture. The calcium carbonate may include ground calcium carbonate (GCC), precipitated calcium carbonate (PCC), modified GCC, or modified PCC, for example. For example, the inorganic pigment may include a mixture of a calcium carbonate and a clay. The particulate fillers can have an average particle size ranging from 0.1 μm to 20 μm, with a dry weight ratio of halogenated polyurethane polymer to particulate filler ranging from 100:1 to 1:20, from 50:1 to 10:1, from 20:1 to 5:1, or from 10:1 to 1:1, for example. A specific example of a particulate filler that can be used is NUCAP®, which is available from Kamin, LLC, USA.

In some examples, there are other additives that can be used or included, such as coating composition thickener, such as TYLOSE® HS-100K, available from SE Tylose GmbH & Co. KG, Germany. Surfactant, such as BYK-DYNWET® 800, available from BYK (Germany), or PLURONIC® L61, available from BASF SE, Germany, can also be included. Other commercially-available surfactants that can be used include the TAMOL™ series from Dow Chemical Co., nonyl and octyl phenol ethoxylates from Dow Chemical Co., USA (e.g., TRITON™ X-45, TRITON™ X-100, TRITON™ X-114, TRITON™ X-165, TRITON™ X-305 and TRITON™ X-405) and other suppliers (e.g., the T-DET™ N series from Harcros Chemicals, USA), alkyl phenol ethoxylate (APE) replacements from Dow Chemical Co., Elementis Specialties, and others, various members of the SURFYNOL® series from Air Products and Chemicals, USA, (e.g., SURFYNOL® 104, SURFYNOL® 104A, SURFYNOL® 104BC, SURFYNOL® 104DPM, SURFYNOL® 104E, SURFYNOL® 104H, SURFYNOL® 104PA, SURFYNOL® 104PG50, SURFYNOL® 104S, SURFYNOL® 2502, SURFYNOL® 420, SURFYNOL® 440, SURFYNOL® 465, SURFYNOL® 485, SURFYNOL® 485W, SURFYNOL® 82, SURFYNOL® CT-211, SURFYNOL® CT-221, SURFYNOL® OP-340, SURFYNOL® PSA204, SURFYNOL® PSA216, SURFYNOL® PSA336, SURFYNOL® SE and SURFYNOL® SE-F), CAPSTONE® FS-35 from DuPont (USA), various fluorocarbon surfactants from 3M. E.I. DuPont, and other suppliers, and phosphate esters from Ashland, Rhodia and other suppliers.

### Coated Fabric Media

The coating compositions described herein can be suitable for use with many types of print media, including paper, fabric, plastic, e.g., plastic film, metal, e.g., metallic foil, and other types of printable substrates, including combinations and/or composites thereof. In particular, textiles or fabrics can be treated with the coating compositions of the present disclosure, including cotton fibers, treated and untreated cotton substrates, polyester substrates, nylons, blended substrates thereof, etc. It is notable that the term “fabric substrate” or “fabric print media substrate” does not include print media substrate materials such as any paper (even though paper can include multiple types of natural and synthetic fibers or mixtures of both types of fibers). Example natural fiber fabrics that can be used include treated or untreated natural fabric textile substrates, e.g., wool, cotton, silk, linen, jute, flax, hemp, rayon fibers, thermoplastic aliphatic polymeric fibers derived from renewable resources such as cornstarch, tapioca products, or sugarcanes, etc. Example synthetic fibers that can be used include polymeric fibers such as nylon fibers (also referred to as polyamide fibers), polyvinyl chloride (PVC) fibers, PVC-free fibers made of polyester, polyamide, polyimide, polyacrylic, polypropylene, polyethylene, polyurethane, polystyrene, polyaramid, e.g., KEVLAR® (E. I. du Pont de Nemours Company, USA), polytetrafluoroethylene, fiberglass, polytrimethylene, polycarbonate, polyethylene terephthalate, polyester terephthalate, polybutylene terephthalate, or a combination thereof. In some examples, the fiber can be a modified fiber from the above-listed polymers. The term “modified fiber” refers to one or both of the polymeric fiber and the fabric as a whole having undergone a chemical or physical process such as, but not limited to, copolymerization with monomers of other polymers, a chemical grafting reaction to contact a chemical functional group with one or both of the polymeric fiber and a surface of the fabric, a plasma treatment, a solvent treatment, acid etching, or a biological treatment, an enzyme treatment, or antimicrobial treatment to prevent biological degradation.

Thus, the fabric substrate can include natural fiber and synthetic fiber, e.g., cotton/polyester blend. The amount of the fiber types can vary. For example, the amount of the natural fiber can vary from 1 wt % to 99 wt % and the amount of the synthetic fiber can range from 1 wt % to 99 wt %. In yet another example, the amount of the natural fiber can vary from 10 wt % to 80 wt % and the synthetic fiber can be present from 20 wt % to 90 wt %. In other examples, the amount of the natural fiber can be 10 wt % to 90 wt % and the amount of the synthetic fiber can also be 10 wt % to 90 wt %. Likewise, the ratio of natural fiber to synthetic fiber in the fabric substrate can vary. For example, the ratio of natural fiber to synthetic fiber can be 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, 1:99, or vice versa. The fabric substrate can be in one of many different forms, including, for example, a textile, a cloth, a fabric material, fabric clothing, or other fabric product suitable for applying ink. In some examples, the fabric substrate can include individual strands and void spaces between the individual strands. In certain examples, the individual strands can be yarn strands. As used herein, “yarn” and “yarn strand” refer to a plurality of threads. In some cases, the plurality of threads can be spun together to form a yarn strand. In further examples, the fabric substrate can have any of a number of fabric structures, including structures that can have warp and weft, and/or can be woven, non-woven, knitted, tufted, crocheted, knotted, and pressured, for example.

It is to be further understood that different yarn strands may be used together in the fabric substrate. In some examples, the yarn strands used in the fabric substrate include a combination or mixture of two or more threads made from the above-listed natural fibers, a combination or mixture of threads of any of the above-listed natural fibers with another natural thread or with a synthetic thread, or a combination or mixture of two or more from the natural threads with another natural thread or with a synthetic thread. In other examples, the yarn strands used in the fabric substrate include a combination or mixture of two or more synthetic threads, a combination or mixture of threads of any of the above-listed synthetic fibers with another synthetic thread or with a natural thread, or a combination or mixture of two or more threads of the above-listed synthetic fibers with another synthetic thread or with a natural thread. As such, some examples of the fabric substrate include one yarn containing natural threads and another yarn containing synthetic threads.

When the fabric substrate includes yarn strands of synthetic threads, the amount of the synthetic yarn strands may range from 20 wt % to 90 wt % of the total amount of yarn strands. When the fabric substrate includes yarn of natural threads, the amount of the natural yarn strands may range from 10 wt % to 80 wt % of the total amount of yarn strands. When the fabric substrate includes yarn strands of synthetic threads and yarn strands of natural threads (e.g., as a woven structure), the amount of the synthetic yarn strands may be about 90 wt % of the total amount of the yarn strands in the fabric substrate, while the amount of the natural yarn strands may be about 10 wt % of the total amount of the yarn strands in the fabric substrate.

In certain examples, the fabric substrate can be a woven fabric where warp yarns and weft yarns are mutually positioned at an angle of about 90°. This woven fabric may include fabric with a plain weave structure, fabric with twill weave structure where the twill weave produces diagonal lines on a face of the fabric, or a satin weave. In another example, the fabric substrate can be a knitted fabric with a loop structure including one or both of warp-knit fabric and weft-knit fabric. The weft-knit fabric refers to loops of one row of fabric that are formed from the same yarn strands. The warp-knit fabric refers to every loop in the fabric structure that is formed from separate yarn strands, mainly introduced in a longitudinal fabric direction.

In a specific example, the fabric substrate can be woven, knitted, non-woven or tufted and can include yarn strands selected from the group consisting of wool, cotton, silk, rayon, thermoplastic aliphatic polymers, polyesters, polyamides, polyimides, polypropylene, polyethylene, polystyrene, polytetrafluoroethylene, fiberglass, polycarbonates polytrimethylene terephthalate, polyethylene terephthalate, polybutylene terephthalate, and combinations thereof.

The yarn strands may also be configured as fibers or filaments. In these examples, the fabric base substrate can be a non-woven product. The plurality of yarn fibers or filaments may be bonded together and/or interlocked together by a chemical treatment process (e.g., a solvent treatment), a mechanical treatment process (e.g., embossing), a thermal treatment process, a treatment including another substance (such as an adhesive), or a combination of two or more of these processes.

It is to be understood that the configurations of the yarn strands discussed herein can include voids among the yarn strands. As such, the fiber substrate can be porous. The void can encompass the entire space (extending in the X, Y, and Z directions) between adjacent yarn strands. Thus, the shape and dimensions of voids can depend upon the yarn strand and its configuration (e.g., woven, non-woven, etc.).

The fabric substrate may be subjected to pre-finishing treatment(s), such as desizing, scouring, bleaching, washing, a heat setting process, and/or treatment with various additives. Examples of suitable additives include colorants (e.g., pigments, dyes, tints), antistatic agents, brightening agents, nucleating agents, antioxidants, UV (ultraviolet light) stabilizers, fillers, and lubricants. As an example, the fabric substrate may be pre-treated in a solution containing the substances listed above before applying the coating composition. The additives and/or pre-treatments may be included to augment various properties of the fabric substrate. The amount of any given additive included in the fabric substrate depends upon the additive, but may range from 0.1 wt % to 5 wt %.

The basis weight of the fabric substrate can be from 20 gsm to 500 gsm, from 40 gsm to 400 gsm, from 50 gsm to 250 gsm, from 50 gsm to 400 gsm, or from 75 gsm to 150 gsm, for example. Some substrates can be toward the thinner end of the spectrum, and other substrates may be thicker, and thus, the weight basis ranges given are provided by example, and are not intended to be limiting.

When the coating composition is applied to the fabric substrate, the coating composition can be dried and/or cured to form a dry coating on the fabric substrate. The coating can add to the weight of the fabric substrate. In some examples, the coating can have a dry coat weight from 0.2 gsm to 8 gsm. In further examples, the coating can have a dry coat weight from 0.2 gsm to 4 gsm, or from 0.2 gsm to 2 gsm, or from 0.2 gsm to 1 gsm, or from 1 gsm to 8 gsm, or from 2 gsm to 8 gsm, or from 4 gsm to 8 gsm. In other examples, the dry coat weight can be 4.5 gsm or less, or 2.5 gsm or less. The total weight of the coated fabric medium can include the basis weight of the fabric substrate, the dry coat weight of the coating, plus the weight of any other additives that are added to the fabric substrate. In some examples, the total weight of the coated fabric medium can be from 21 gsm to 520 gsm, or from 40 gsm to 400 gsm, from 50 gsm to 250 gsm, from 50 gsm to 400 gsm, or from 75 gsm to 150 gsm.

The coating composition can be applied in an amount that coats individual strands of the fabric substrate without forming a continuous film across the entire surface of the fabric substrate, in some examples. Therefore, void spaces between the individual strands can remain open after the coating has been applied. The voids that are present after the coated has been applied can also be referred to as pore spaces. The pore spaces can coincide with the original voids in the fabric substrate, meaning that the pore spaces substantially align with the void spaces so that the void spaces remain open to air flow. As explained above, this can increase the flexibility of the coated fabric medium and reduce the dark line effect that may be caused by folding the coated fabric medium. In certain examples, all void spaces in the fabric substrate can remain open after applying the coating. However, in some examples, some void spaces can be filled in by the coating while other void spaces remain open. For example, from 30% to 100% of the void spaces can remain open after applying the coating composition. In other examples, from 30% to 99% of the void spaces can remain open, or from 50% to 99% of the void spaces, or from 70% to 99% of the void spaces, or from 80% to 99% of the void spaces can remain open, or from 95% to 100% of the void spaces can remain open. Open void spaces can be detected visually using a microscope. The porosity can also be tested by measuring air flow through the medium using the Tappi method T526 (T526 (e.g., using a Hagerty Technologies instrument (from Technidyne)) or using Tappi method T-555 (e.g., using a Parker Print-Surf instrument (from Testing Machines, Inc.)), or with another like method and/or instrument.

The coating can provide the fabric substrate with ink receiving properties and durability, while also maintaining the flexibility of the fabric base substrate, and providing flame retardant properties. The characteristics of the coating are due, in part, to the cross-linked polymer network and the halogenated polyurethane in the coating. The cross-linked polymer network can be capable of holding applied ink at the image-side, which increases image quality. The cross-linked polymer network can also be mechanically strong, which contributes to increased durability. The cross-linked polymer network can form the pore spaces described above, which contributes to maintaining the flexibility of the fabric substrate. Additionally, the halogenated polyurethane can contribute flame retardant properties. In some examples, the coating can be devoid of other halogenated flame retardant compounds that could migrate out of the coating over time.

### Methods of Making Coated Fabric Media

The coating compositions described herein can be applied to any print media substrate type using any method appropriate for the coating application properties, e.g., thickness, viscosity, etc. Non-limiting examples of methods include dipping coating, padding, spray coating, slot die, blade coating, and Meyer rod coating. When the coating composition is dried by removal of water and/or other volatile solvent content, the coating composition can form a coating layer. Drying can be carried out by air drying, heated airflow drying, baking, infrared heated drying, etc. Other processing methods and equipment can also be used.

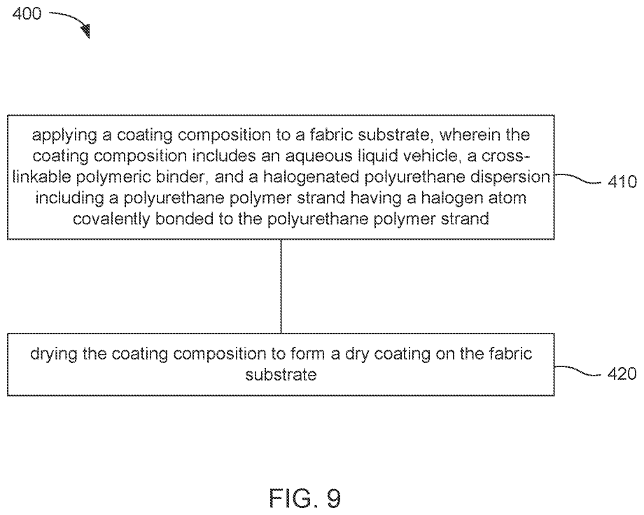

FIG. 9 is a flowchart illustrating one example method 400 of making a coated fabric medium. The method includes: applying a coating composition to a fabric substrate, wherein the coating composition includes an aqueous liquid vehicle, a cross-linkable polymeric binder, and a halogenated polyurethane dispersion including a polyurethane polymer strand having a halogen atom covalently bonded to the polyurethane polymer strand 410; and drying the coating composition to form a dry coating on the fabric substrate 420.

In further examples, methods of making coated fabric media can include the preparation of the coating composition. For example, the coating composition can include reactive ingredients such as curing agents or hardeners that can cause the coating composition to have a limited pot life. The curing agent can react with the cross-linkable polymeric binder to form cross-linking. In certain examples, the method of making a coated fabric medium can include mixing the curing agent in the coating composition before applying the coating composition to the fabric substrate. The coating composition can be applied to the fabric substrate within the pot life of the coating composition after adding the curing agent.

In further detail and by way of example, the fabric substrate can be modified on a single side or both sides with the coating composition. The coating composition can form a coating that is at the outermost surface of the print media, such that the coating is an ink-receiving layer when ink is printed on the media. In certain examples, a pre-coat layer can be formed on the substrate first, followed by an ink-receiving layer formed over the pre-coat layer. In such examples, the pre-coat layer and the ink-receiving layer can both be coating compositions as described herein. In specific examples, the pre-coat layer can be formed from a coating composition that includes inorganic filler particles and the ink receiving layer can be formed from a coating composition that does not include inorganic filler particles.

The coated fabric substrate can also be calendar pressed, in some examples. In certain examples, the methods of making the coated fabric substrates can include drying the coated fabric substrate after applying the coating composition and calendar pressing the coated fabric substrate after drying. Calendar pressing can be performed using a calendaring apparatus, such as off-line super-calendar, on-line calendar, soft-nip calendar, hard-nip calendar, or others. In some cases calendaring can include passing the coated fabric substrate between a pair of rollers. The rollers can apply pressure to the coated substrate to smooth the surface of the coated substrate. In some examples, the coated fabric substrate can be calendared with a calendaring pressure from 500 pounds per square inch (PSI) to 5,000 PSI. In further examples, the calendaring pressure can be from 1,000 PSI to 3,000 PSI.

It is noted that, as used in this specification and the appended claims, the singular forms “a,” “an,” and “the” include plural referents unless the content clearly dictates otherwise.

As used herein, the term “about” is used to provide flexibility to a numerical range endpoint by providing that a given value may be “a little above” or “a little below” the endpoint. The degree of flexibility of this term can be dictated by the particular variable based on experience and the associated description herein.

As used herein, a plurality of items, structural elements, compositional elements, and/or materials may be presented in a common list for convenience. However, these lists should be construed as though the members of the list are individually identified as separate and unique members. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include the numerical values explicitly recited as the limits of the range, and also to include all the individual numerical values or sub-ranges encompassed within that range as if the numerical values and sub-ranges are explicitly recited. For example, a weight ratio range of about 1 wt % to about 20 wt % should be interpreted to include the explicitly recited limits of about 1 wt % and about 20 wt %, and also to include individual weights such as 2 wt %, 11 wt %, 14 wt %, and sub-ranges such as 10 wt % to 20 wt %, 5 wt % to 15 wt %, etc.

### EXAMPLES

The following examples illustrate the technology of the present disclosure. However, it is to be understood that the following is merely illustrative of the methods and systems herein. Numerous modifications and alternative methods and systems may be devised without departing from the present disclosure. Thus, while the technology has been described above with particularity, the following provides further detail in connection with what are presently deemed to be the acceptable examples.

### Example 1—Sample Coated Fabric Media

A series of coated fabric media were prepared. The same fabric substrate was used in all of the samples: 100% polyester fabric with a plain weave and a basis weight of 105 gsm. Two experimental examples were prepared according to the present disclosure. The two experimental examples were made by coating the fabric substrate with different coat weights of the same example coating composition. Besides the two experimental examples, four comparative examples were also prepared. The experimental and comparative examples are qualitatively described in Table 1.

TABLE 1
Coated Fabric Media

| Example No. | Description |
|---|---|
| 1 | Coating includes halogenated polyurethane, non- |
| | continuous film |
| 2 | Coating includes halogenated polyurethane, non- |
| | continuous film |
| 3 (comparative) | Non-halogenated polyurethane with unbonded FR agent |
| 4 (comparative) | Non-halogenated polyurethane without FR agent |
| 5 (comparative) | Base fabric substrate without coating |
| 6 (comparative) | Coating includes halogenated polyurethane, continuous |
| | film |

The coating formulations and coat weights of the sample coated fabric substrates are shown in Table 2. The amounts of the ingredients in the coating formulations are shown in parts by dry weight, and the coat weights are shown in grams per meter (gsm).

TABLE 2

| | Example No. | | | | | |
|---|---|---|---|---|---|---|
| Ingredient | 1 | 2 | 3 | 4 | 5 | 6 |
| BYK-DYNWET ® 800 | 0.2 | 0.2 | 0.2 | 0.2 | — | 0.2 |
| ARALDITE ® PZ 3901 | 5 | 5 | 5 | 5 | — | 5 |
| ARADUR ® 3985 | 5 | 5 | 5 | 5 | — | 5 |
| SANCURE ® 1073C | 6 | 6 | — | — | — | 6 |
| SANCURE ® 2026 | — | — | 6 | 6 | — | — |
| SPACERITE ® S3 | 25 | 25 | — | 25 | — | 25 |
| SAYTEX ® BT-93 | — | — | 18.3 | — | — | — |
| Antimony | — | — | 9 | — | — | — |
| AEROSOL ® OT-70 | — | — | 0.075 | — | — | — |
| Deionized Water | balance | | | | | |
| Coat Weight (gsm) | 1.2 | 3.0 | 5.7 | 3.1 | 0 | 10.6 |

BYK-DYNWET ® 800 is a surfactant available from BYK (Germany); ARALDITE ® PZ 3901 is a cross-linkable polymeric binder available from Huntsman International LLC (USA); ARADUR ® 3985 is cross-linker for the cross-linkable polymeric binder available from Huntsman International LLC (USA); SANCURE ® 1073C is a halogenated polyurethane available from Lubrizol Inc. (USA); SANCURE ® 2026 is a non-halogenated polyurethane available from Lubrizol Inc. (USA); SPACERITE ® S3 is an inorganic filler available from Huber Engineered Materials (USA); SAYTEX ® BT-93 is a halogenated flame retardant available from Albemarle (USA); Antimony is used as a synergist; and AEROSOL ® OT-70 is a dispersant for the flame retardant available from Dow Chemical (USA).

The coating compositions were applied to the fabric substrates for examples 1, 2, and 4 using a lab Methis padder with a padding pressure of 50 PSI, and the coating composition was dried using a hot air oven with a peak temperature of 120° C. The coatings of comparative examples 3 and 6 were deposited on the fabric substrate using a Mayer rod and dried using a hot air oven with a peak temperature of 120° C. All the samples were subjected to calendar pressing at room temperature with a calendar pressure of 2,000 PSI.

### Example 2—Print Quality and Durability Tests

The coated fabric substrates were tested for porosity by measuring the air flow (mL/min) through the media using the Tappi method T526, using a Hagerty Technologies instrument or using Tappi method T-555 using a Parker Print Surf instrument. Hole openness was also evaluated by viewing under a microscope. The results were given a rating from 1 to 5, where 5 is the most open pores and 1 is closed pores.

The substrates were printed with a black latex ink using an HP L-360 latex ink printer. Media gloss was tested using a gloss meter from BYK Gardner, which measured gloss at 60°. Black optical density was measured using an X-RITE® spectrodensitometer from X-Rite, Inc. (USA). For fold testing, the sample is folded like a bed sheet 4 times, then a 20 pound weight is placed on the folded sample for 30 minutes. The results were given a score of 1 to 5, where 5 is best with no ink removal, and 1 is worst with ink removed and white lines formed along the folds.

Dry Rub resistance was tested by using an abrasion scrub tester including a cylinder with a cloth wrapped on one end of the cylinder. The cloth was rubbed back and forth 5 times, with a weight ranging from 180 g to 800 g. The device used was a 5750 linear abraser from Taber Industries. The results were given a rating from 1 to 5, where 5 is best with no ink removal, and 1 is worst with ink removed. Scratch testing was carried out using a coin to scratch the ink printed on the coated fabric substrates. The 5750 linear abraser from Taber Industries was used for this test, with a coin holder attachment. This test was also given a rating from 1 to 5, similar to the dry rub test. Gamut was measured using a MACBETH® TD904 (Macbeth Process Measurement) machine.

Flame retardance (FR) or resistance was evaluated based on NFPA 701 standard (Standard Methods of Fire Tests for Flame Propagation of Textiles and Films). This methodology measures ignition resistance of a fabric after it is exposed to a flame for 12 seconds, and then the flame, char length, and flaming residue are recorded, with “passing” criteria based on a total weight loss less than 40 w % after burning, and a burning time of residual drops at less than 2 seconds. “Residual drops” refer to the melted burning drops from the fabric substrate that occur during the burning test when the samples are handled vertically. The results of these tests are shown in Table 3.

TABLE 3

| | | | Black | | | | | |
|---|---|---|---|---|---|---|---|---|
| Example | | Media | Optical | Color | Coin | Dry | Fold | |
| No. | Porosity | Gloss | Density | Gamut | Scratch | Rub | Resistance | FR |
| 1 | 455 | 3.0 | 2.8 | 712K | 5 | 4.5 | 5 | Pass |
| | (5-open) | | | | | | | |
| 2 | 382 | 3.0 | 2.8 | 720K | 5 | 5 | 4.5 | Pass |
| | (5-open) | | | | | | | |
| 3 | 2.7 | 8.5 | 2.7 | 805K | 5 | 3 | 1 | Pass |
| (comp) | (1-closed) | | | | | | | |
| 4 | 420 | 3.5 | 2.3 | 698K | 5 | 5 | 4.5 | Fail |
| (comp) | (5-open) | | | | | | | |
| 5 | 462 | 2.0 | 1.1 | 433K | 1 | 2 | 5 | Borderline |
| (comp) | (5-open) | | | | | | | Pass |
| 6 | 19.8 | 5.0 | 2.7 | 747K | 5 | 5 | 2 | Pass |
| (comp) | (2-partially | | | | | | | |
| | closed) | | | | | | | |

As can be seen by the data collected in Table 3, the samples that had open pores had better fold resistance. The open pores indicate that the void spaces in the fabric were not blocked by the coating. Therefore, the coating did not form a continuous film on the surface of the fabric substrate. The non-continuous coating had similar gloss, optical density, color gamut, dry rub, and scratch resistance to the samples with a more continuous coating layer. Therefore, it can be seen that the non-continuous coating is suitable for printing. Additionally, the halogenated polyurethane is sufficiently flame retardant to allow the coated fabric media to pass the flame retardance test. The best results were provided by Examples 1 and 2. These were the examples that included the halogenated polyurethane in the coating composition and which had open pores due to a low coat weight of the coating composition. As can be seen from comparative Example 4, using a coating composition without the halogenated polyurethane or other flame retardant results in failure of the flame retardance test. The comparative Example 3 included an un-bonded flame retardant agent, which can migrate out of the coating over time and cause environmental pollution. The comparative Example 3 was also applied at a heavier coat weight, so that the pores were closed. As a result, the fold resistance was poor. Additionally, comparative Example 6 had a high coat weight and also had poor fold resistance. Comparative Example 5 did not include any coating on the fabric substrate. As a result, this fabric had very low durability in the coin scratch test and the dry rub test.

What is claimed is:

1. A coating composition, comprising:
an aqueous liquid vehicle;
a cross-linkable polymeric binder; and
a halogenated polyurethane dispersion comprising a polyurethane polymer strand having a halogen atom covalently bonded to the polyurethane polymer strand.

2. The coating composition of claim 1, wherein the aqueous liquid vehicle makes up from 90 wt % to 99 wt % of the coating composition.

3. The coating composition of claim 1, wherein the cross-linkable polymeric binder comprises polyacrylate, polyurethane, vinyl-urethane, acrylic urethane, polyurethane-acrylic, polyether polyurethane, polyester polyurethane, polycaprolactam polyurethane, polyether polyurethane, alkyl epoxy resin, epoxy novolac resin, polyglycidyl resin, polyoxirane resin, polyamine, styrene maleic anhydride, or a combination thereof.

4. The coating composition of claim 1, wherein the cross-linkable polymeric binder comprises an epoxy resin dispersion.

5. The coating composition of claim 4, wherein the coating composition further comprises a curing agent selected from the group consisting of an amine, a polyamide, an anhydride, an imidazole, or a combination thereof.

6. The coating composition of claim 1, wherein the halogen atom includes chlorine, bromine, or a combination thereof.

7. The coating composition of claim 1, wherein the halogenated polyurethane polymer strand comprises polymerized monomers including a polyisocyanate, a polyol, and a monoalcohol end cap monomer, and wherein the halogen atom is included in the polyol, the monoalcohol end cap monomer, or both.

8. The coating composition of claim 7, wherein the polyol, the monoalcohol end cap monomer, or both include a polyalkylene oxide group.

9. The coating composition of claim 8, wherein the halogen atom is included in the monoalcohol end cap monomer and wherein the polyalkylene oxide group is a polypropylene oxide group or polyethylene oxide group included as a side chain of the polyol.

10. The coating composition of claim 8, wherein the halogen atom is included in a side chain of the polyol and wherein the polyalkylene oxide group is a polypropylene oxide group or polyethylene oxide group included in the monoalcohol end cap monomer.

11. A coated fabric medium, comprising:
a fabric substrate; and
a coating on the fabric substrate, the coating comprising a cross-linked polymeric network and a halogenated polyurethane polymer strand having a halogen atom covalently bonded to the polyurethane polymer strand.

12. The coated fabric medium of claim 11, wherein the fabric substrate comprises individual strands and void spaces between the individual strands, wherein the coating is on surfaces of the individual strands such that the void spaces remain between the individual strands.

13. The coated fabric medium of claim 11, wherein the coating has a dry coat weight from 0.2 grams per square meter to 8 grams per square meter.

14. A method of making a coated fabric medium, comprising:
applying a coating composition to a fabric substrate, wherein the coating composition comprises:
an aqueous liquid vehicle,
a cross-linkable polymeric binder, and
a halogenated polyurethane dispersion comprising a polyurethane polymer strand having a halogen atom covalently bonded to the polyurethane polymer strand; and
drying the coating composition to form a dry coating on the fabric substrate.

15. The method of claim 14, the coating composition further comprising a curing agent to cross-link the cross-linkable polymeric binder, wherein the method further comprises mixing the curing agent in the coating composition before applying the coating composition to the fabric substrate, and wherein the method further comprises curing the coating composition after applying the coating composition to the fabric substrate.

16. The method of claim 15, further comprising calendar pressing the coated fabric substrate after drying.
